(19) United States
(12) Patent Application Publication
(10) Pub. No.: US 2010/0031002 A1
(43) Pub. Date: Feb. 4, 2010

(54) SIMD MICROPROCESSOR AND OPERATION METHOD

(76) Inventor: Hidehito Kitamura, Osaka (JP)

Correspondence Address: DICKSTEIN SHAPIRO LLP, 1825 EYE STREET NW, Washington, DC, 20006-5403, US

(21) Appl. No.: 12/495,853

(22) Filed: Jul. 1, 2009

(30) Foreign Application Priority Data
Jul. 30, 2008 (JP) 2008-196426

(51) Int. Cl. G06F 15/80; G06F 9/06

(52) U.S. Cl. 712/22; 712/E09.003

(57) ABSTRACT

A disclosed SIMD microprocessor includes a processor element unit including multiple processor elements; and a global processor unit configured to interpret a program pre-recorded in a memory and supply a control signal to the processor element unit. Each of the processor elements includes an operational circuit; a first forwarding path for forwarding, to an input side of the operational circuit, an operation result obtained by the operational circuit; second forwarding paths, each of which forwards, to the input side of the operational circuit, an operation result obtained by an operational circuit of a neighboring processor element among the multiple processor elements; and a selection unit configured to select one of the first forwarding path and the second forwarding paths.

### BACKGROUND OF THE INVENTION

1. Field of the Invention

The present invention is directed to a SIMD (Single Instruction-stream, Multiple Data-stream) microprocessor for performing parallel processing of multiple data pieces and the like with a single operation instruction, and is also directed to an operation method using such a SIMD microprocessor.

2. Description of the Related Art

In recent years, performance advances including increases in the number of pixels and color-enabled applications have progressed in image processing apparatuses, such as digital copiers and facsimile machines. With the performance advances, the number of data pieces to be processed has increased. It is often the case that the same operation processes are performed over all pixels. Accordingly, SIMD microprocessors capable of simultaneously performing the same operation processes on multiple data pieces with a single instruction (see Patent Documents 1 and 2) have been increasingly used.

FIG. 9 shows a conventionally-used, general-purpose SIMD microprocessor. With reference to FIG. 9, a SIMD microprocessor 100 includes a global processor unit 101, a processor element unit 102, an external input and output unit 103 and an image memory 104.

The global processor unit 101, which is a so-called SISD (Single Instruction-stream, Single Data-stream) microprocessor, incorporates a program RAM and a data RAM, interprets programs and controls various control signals. The control signals are not only supplied for controlling various incorporated blocks but also supplied to register files 1021a and operation units 1021b (to be described later) of the processor element unit 102. In addition, at the time of execution of a global processor instruction with which operation processes are carried out using a computing unit (not shown) of the global processor unit 101, the global processor unit 101 performs various operation processes and program control processes using built-in general-purpose registers, ALUs (arithmetic and logic units) and the like.

The processor element unit 102 includes multiple processor elements 1021. The processor element unit 102 is controlled by processor element instructions executed by the global processor unit 101. A processor element instruction is a SIMD instruction, and causes the same processes to be simultaneously performed on multiple pieces of data stored in the register files 1021a (to be described below). The processor elements 1021 include the register files 1021a and the operation units 1021b.

The register files 1021a store data to be processed by a processor element instruction. Data reading and writing from/to the register files 1021a are achieved by control of the global processor unit 101. Data read from each register file 1021a are sent to a corresponding operation unit 1021b, which performs an operation process on the data. Subsequently, the data after the operation process are written to the register file 1021a. The register files 1021a can also be accessed from the outside of the processor, and reading or writing of a particular register can be performed from the outside, aside from control of the global processor unit 101.

In the operation units 1021b, operation processes specified by a processor element instruction are executed. The processes in the operation units 1021b are controlled solely by the global processor unit 101.

The external input and output unit 103 reads, from the image memory 104 to be described below, original image data to be processed and writes the original image data to the register files 1021a, or reads post-processed image data from the register files 1021a and writes the image data to the image memory 104.

The image memory 104 stores original image data to be processed and post-processed image data. Among pipeline hazards likely to occur in this type of processors, there is one called a read after write (RAW) hazard. A read after write hazard is created in the case where a first (preceding) instruction to overwrite a register is issued and then a second (subsequent) instruction to read data from the same register is issued. Even though the overwriting operation executed by the first instruction has yet to be completed, the reading operation by the second instruction starts. When such a hazard occurs, it is often the case that data consistency is ensured by stalling the pipeline. Pipeline stall results in using extra cycles. Accordingly, in order to assure data consistency and prevent extra cycles, a forwarding path that functions as a bypass is provided in the data path of a processor element so as to send an operation result of an ALU to the input side. Forwarding (bypassing) is achieved by controlling such forwarding paths, thereby avoiding pipeline stall.
[Patent Document 1] Japanese Patent Publication No. 4020804
[Patent Document 2] Published Japanese Translation No. 2000-187729 of the PCT International Publication

However, there is a problem in SIMD microprocessors including processor elements, each of which reads data from a neighboring processor element (or itself), carries out an operation at an ALU of itself, and writes the operation result in a neighboring processor element (or itself). That is, in the case where a processor element for the writing operation is different from a processor element for the reading operation, consistency of the operation processes cannot be assured by the conventional control in which, for example, a forwarding path is selected simply because of an address match of a register file.

### SUMMARY OF THE INVENTION

The present invention aims at solving the above-described problem.

That is, the present invention relates to a SIMD microprocessor for performing data communication with neighboring processor elements, and aims at providing such a SIMD microprocessor capable of performing appropriate forwarding control. The present invention also aims at providing an operation method applied to such a SIMD microprocessor so as to perform appropriate forwarding control.

A SIMD microprocessor according to one aspect of the present invention includes a processor element unit including multiple processor elements; and a global processor unit configured to interpret a program pre-recorded in a memory and supply a control signal to the processor element unit. Each of the processor elements includes an operational circuit; a first forwarding path for forwarding, to an input side of the operational circuit, an operation result obtained by the operational circuit; second forwarding paths, each of which forwards, to the input side of the operational circuit, an operation result obtained by an operational circuit of a neighboring processor element among the multiple processor elements; and a selection unit configured to select one of the first forwarding path and the second forwarding paths.

A SIMD microprocessor according to another aspect of the present invention includes a processor element unit including multiple processor elements, each of which includes an operational circuit and a forwarding path for forwarding, to an input side of the operational circuit, an operation result obtained by the operational circuit; a global processor unit configured to interpret a program pre-recorded in a memory and supply a control signal to the processor element unit; and a control unit configured to detect that a processor element specified by a preceding instruction of the program to be a data write processor element in which an operation result is to be written matches a processor element specified by a subsequent instruction of the program to be a data read processor from which the operation result is to be read, and causes the operational circuit to perform an operation using the forwarding path when the detection is made.

An operation method according to one aspect of the present invention is applied to a SIMD microprocessor including a processor element unit which includes multiple processor elements, each of which includes an operational circuit and a forwarding path for forwarding, to an input side of the operational circuit, an operation result obtained by the operational circuit, and a global processor unit configured to interpret a program pre-recorded in a memory and supply a control signal to the processor element unit. The operation method includes the step of selecting, as an input of the operational circuit, one of the operation result obtained by the operational circuit and operation results obtained by operational circuits of neighboring processor elements among the multiple processor elements according to a distance to a processor element specified by a preceding instruction of the program to be a data write processor element in which an operation result is to be written and a distance to a processor element specified by a subsequent instruction of the program to be a data read processor from which the operation result is to be read.

An operation method according to another aspect of the present invention is applied to a SIMD microprocessor including a processor element unit which includes multiple processor elements, each of which includes an operational circuit and a forwarding path for forwarding, to an input side of the operational circuit, an operation result obtained by the operational circuit, and a global processor unit configured to interpret a program pre-recorded in a memory and supply a control signal to the processor element unit. The operation method includes the steps of detecting that a processor element specified by a preceding instruction of the program to be a data write processor element in which an operation result is to be written matches a processor element specified by a subsequent instruction of the program to be a data read processor from which the operation result is to be read; and using the operation result of the forwarding path as an input of the operational circuit when the detection is made.

### BRIEF DESCRIPTION OF THE DRAWINGS

FIG. 1 is a block diagram of a SIMD microprocessor according to the first embodiment of the present invention;

FIG. 2 is a block diagram showing details of a processor element of the SIMD microprocessor of FIG. 1;

FIG. 3 illustrates a pipeline of the SIMD microprocessor of FIG. 1;

FIG. 4 illustrates a relationship between data write and data read among PEs in relation to a preceding instruction and a subsequent instruction;

FIG. 5 is a block diagram of a control circuit used for controlling forwarding paths of the SIMD microprocessor of FIG. 1;

FIG. 6 is a block diagram showing details of a processor element of a SIMD microprocessor according to the second embodiment of the present invention;

FIG. 7 illustrates a relationship between data write and data read among PEs in relation to a preceding instruction and a subsequent instruction;

FIG. 8 illustrates a relationship between data write and data read among PEs in relation to a preceding instruction and a subsequent instruction; and

FIG. 9 is a block diagram of a conventional SIMD microprocessor.

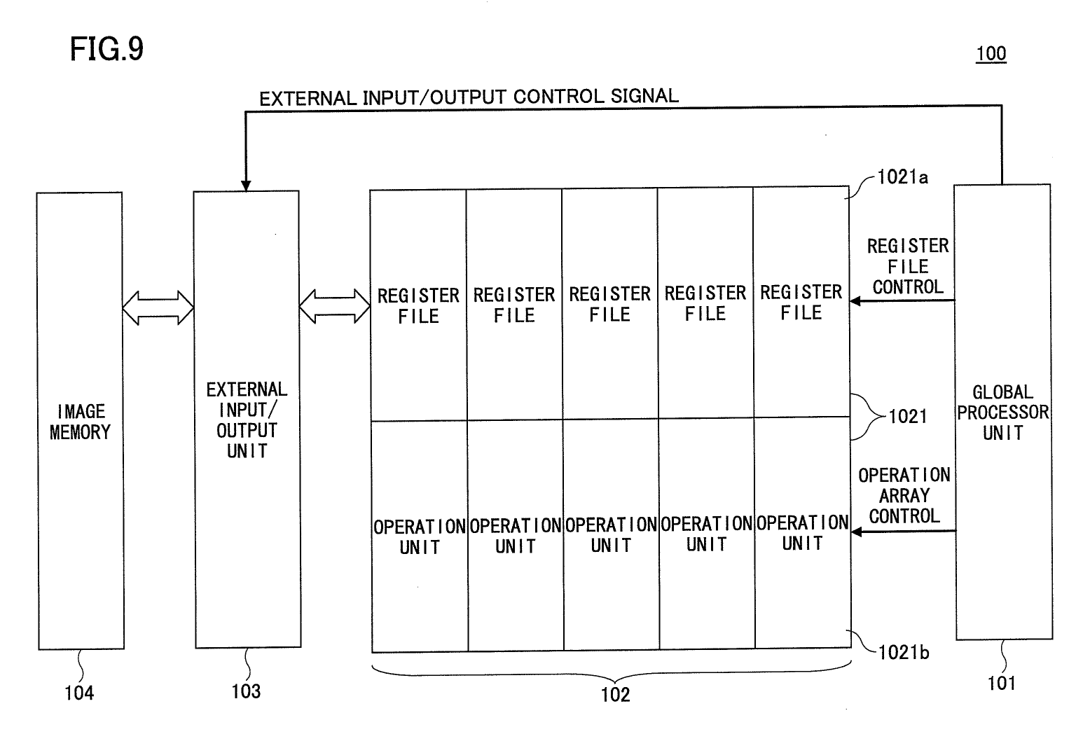

### DETAILED DESCRIPTION OF THE PREFERRED EMBODIMENTS

### First Embodiment

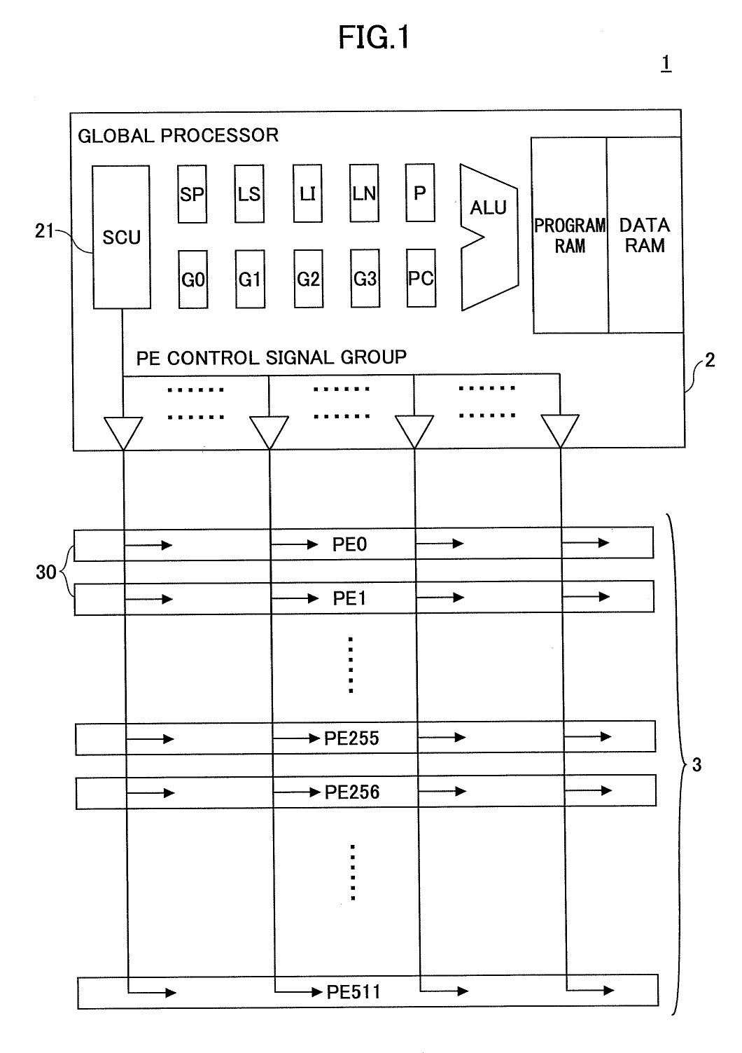

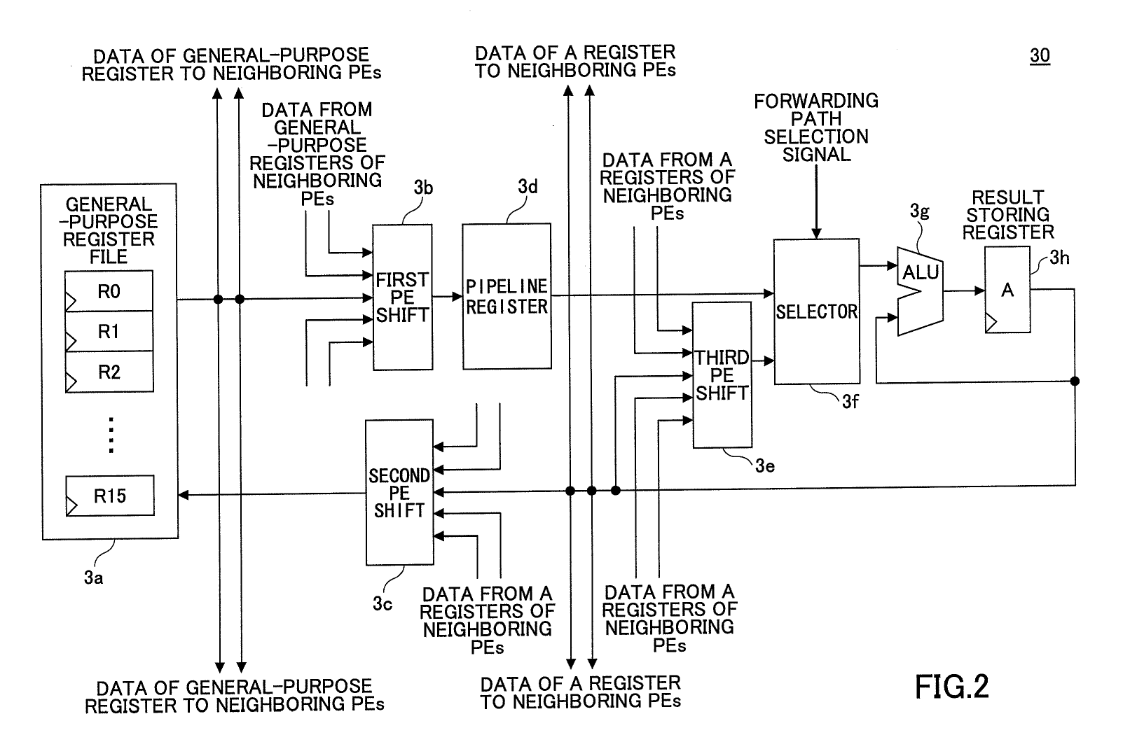

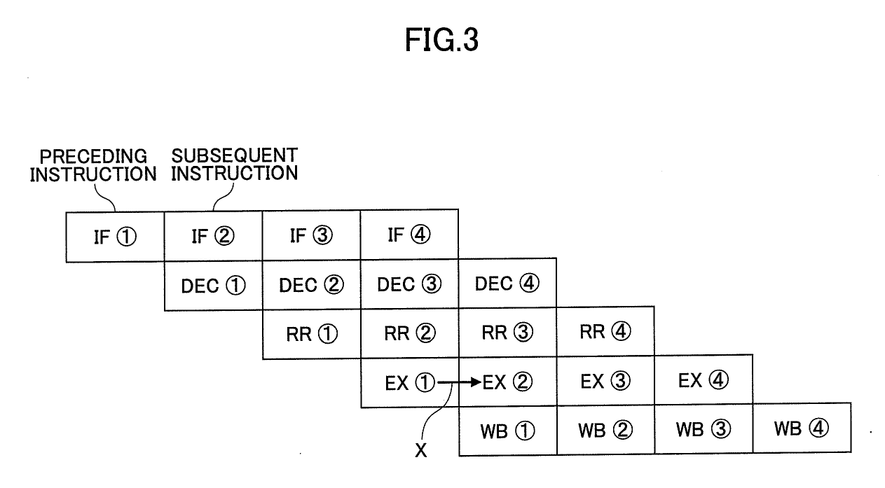

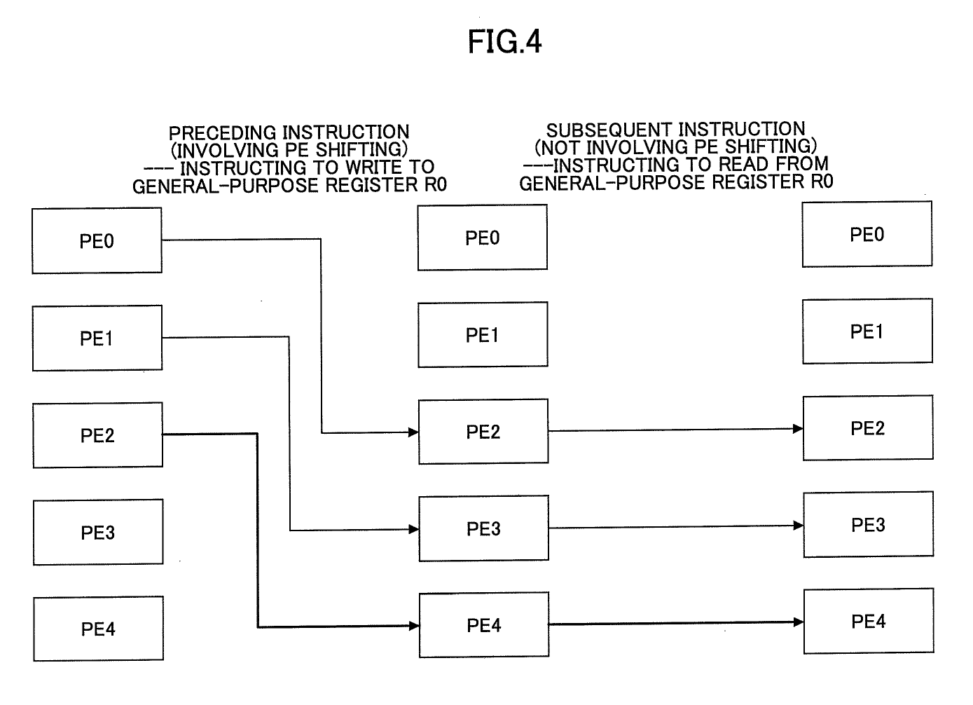

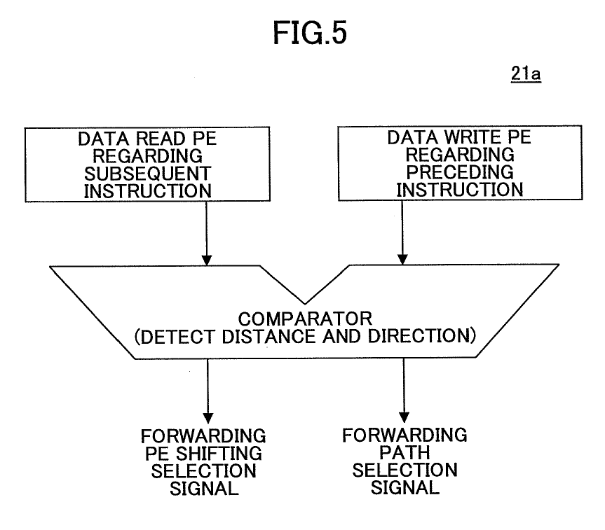

Next is described the first embodiment of the present invention with reference to FIGS. 1 through 5. FIG. 1 is a block diagram showing a SIMD microprocessor according to the first embodiment of the present invention. FIG. 2 is a block diagram showing the details of a processor element of the SIMD microprocessor of FIG. 1. FIG. 3 illustrates a pipeline of the SIMD microprocessor of FIG. 1. FIG. 4 illustrates the relationship between data write and data read among processor elements in relation to a preceding instruction and a subsequent instruction. FIG. 5 is a block diagram of a control circuit used for controlling forwarding paths of the SIMD microprocessor of FIG. 1.

A SIMD microprocessor 1 of FIG. 1 includes a global processor (hereinafter “GP”) unit 2 and a processor element (hereinafter “PE”) unit 3.

The GP unit 2 includes a program RAM for storing programs; a data RAM for storing operation data; a program counter PC for holding addresses of the programs; G0-G3 registers which are general-purpose registers for storing data of operation processes; an ALU for the GP unit 2; a stack pointer SP for holding, at the time of register save and restoration, an address of a save destination in the data RAM; a link register LS for holding, at the time of a subroutine call, an address of a call source; an LI for holding a parent-node address at the time of an interrupt and a NMI (non-maskable interrupt); an LN register; a processor status register P for holding the condition of the GP unit 2; and a sequence unit SCU 21 for interpreting instructions and generating various control signals. Using these components, a GP instruction is implemented.

When the GP unit 2 implements a PE instruction, a control signal generated by the SCU 21 is held by pipeline registers (not shown), and then supplied to individual processor elements (PEs) of the PE unit 3.

The PE unit 3 includes multiple PEs 30. According to the present embodiment, there are 512 PEs 30 (PE0 through PE511). Numbers (e.g. 0-511 as shown in FIG. 1) of the PEs 30 are attached by assigning in advance the numbers to combinations of GND and VDD or to registers.

Each PE 30 includes a general-purpose register file 3a, a first PE shift 3b, a second PE shift 3c, a pipeline register 3d, a third PE shift 3e, a selector 3f, an ALU 3g, and an A register 3h.

The general-purpose register file 3a includes sixteen 16-bit registers R0 through R15, in which data to be processed as specified by a PE instruction are held. Control of data reading and writing from/to the general-purpose register file 3a is performed by the GP unit 2. Data read from the general-purpose register file 3a are output to the ALU 3g via the first PE shift 3b, the pipeline register 3d and the selector 3f to be described below. After an operation process is performed on the data at the ALU 3g, the data go through the second PE shift 3c and are written to the general-purpose register file 3a.

The first PE shift 3b makes a selection, according to a control signal from the GP unit 2, from among data from the general-purpose register file 3a of itself 30 and data from the general-purpose register files 3a of neighboring PEs 30, and outputs the selected data to the pipeline register 3d. Making a selection from among the data of itself 30 and the neighboring PEs 30 is referred to as PE shifting. In the present embodiment, the data shifting, i.e., the data selection, can be made in the ±2 PE range of itself 30 (in the case of FIG. 1, the range includes a PE (itself) 30 and its upper two and lower two neighboring PEs).

The second PE shift 3c makes a selection, according to a control signal from the GP unit 2, from among the general-purpose register file 3a of itself 30 and the general-purpose register files 3a of neighboring PEs 30, and outputs, to the selected general-purpose register file 3a, data of the A register 3h which stores an operation result of the ALU 3g. In the present embodiment, the shifting, i.e., the selection, can be made in the ±2PE range of itself 30 (in the case of FIG. 1, the range includes a PE (itself) 30 and its upper two and lower two PEs).

The pipeline register 3d stores data output from the first PE shift 3b and outputs the data to the selector 3f after delaying the data by one cycle.

The third PE shift 3e functioning as a selection unit makes a selection, according to a control signal from the GP unit 2, from among data of the A register 3h of itself 30 and data of the A registers 3h of neighboring PEs 30, and outputs the selected data to the selector 3f. The third PE shift 3e is able to make an output selection in the ±2 PE range of itself 30 (in the case of FIG. 1, the range includes a PE (itself) 30 and its upper two and lower two PEs). That is, the third PE shift 3e makes the selection from among a path, in itself 30, for forwarding an operation result of the ALU 3g to the input side of the ALU 3g and paths for forwarding operation results of the ALUs 3g of neighboring PEs 30 to the input side of the ALU 3g of itself 30.

The selector 3f makes a selection, according to a control signal (forwarding path selection signal) from the GP unit 2, between data output from the pipeline register 3d and data output from the third PE shift 3e, and outputs the selected data to the ALU 3g.

The ALU 3g functioning as an operational circuit is an arithmetic and logic operational circuit. The ALU 3g performs an operation on data output from the selector 3f and data of the A register 3h based on a control signal from the GP unit 2, and outputs the operation result to the A register 3h.

The A register 3h is a register (accumulator) for storing the operation result of the ALU 3g, and the stored data are output to the ALU 3g, the second PE shift 3c and the third PE shift 3e as well as to the second PE shifts 3c and the third PE shifts 3e of neighboring PEs 30. In the present embodiment, this output is made to the ±2 neighboring PEs, as described above.

As mentioned above, the output of the A register 3h is connected to the third PE shift 3e. This is a path that is designed for avoiding a pipeline hazard by including the selector 3f. The path forwards, within itself 30, the operation result of the ALU 3g to the input side of the ALU 3g. In addition, the paths connecting the A registers 3h of the neighboring PEs 30 to the PE shift 3e of itself 30 are provided for forwarding operation results of the ALUs 3g (stored in the A registers 3h) of the neighboring PEs 30 to the input side of the ALU 3g of itself 30 (in FIG. 2, “data from A registers of neighboring PEs”).

Next is described a pipeline of the SIMD microprocessor 1 having the above-explained structure, with reference to FIG. 3. The SIMD microprocessor 1 basically employs a five-stage pipeline, and the five stages include IF (instruction fetch); DEC (decode); RR (general-purpose register 3a read); EX (ALU execute); and WB (register 3a write back). In the IF stage, processes up to storing data of the program RAM in an instruction register (not shown) of the GP unit 2 are performed. In the DEC stage, an instruction stored in the instruction register is decoded. In the RR stage, data are selected from among those stored in the general-purpose register files 3a of itself 30 and the neighboring ±2 PEs 30, and then the selected data are read and stored in the pipeline register 3d. In the EX stage, the selector 3f makes a selection between the data of the pipeline register 3d and the output data of the third PE shift 3e, and the ALU 3g performs an operation on the selected data input from the selector 3f and stores the operation result in the A register 3h. In the WB stage, the result data stored in the A register are written to one of the general-purpose register files 3a of itself 30 and the neighboring ±2 PEs 30.

The case in which a RAW hazard occurs in the pipeline of FIG. 3 caused by an instruction involving PE shifting is explained next with reference to FIG. 4. A preceding instruction specifies writing of the operation result in the R0 register of the second PE 30 down from itself 30. A subsequent instruction specifies data reading from the R0 register of itself 30. At this point, a RAW hazard related to the R0 register takes place.

In this case, in the SCU 21 of the GP unit 2, a control circuit 21a of FIG. 5 which functions as a controller is provided for performing forwarding control. The control circuit 21a determines a PE 30 for data write operation (hereinafter “data write PE”) regarding the preceding instruction based on the amount and direction of PE shifting specified in the preceding instruction, and determines a PE 30 for data read operation (“data read PE”) regarding the subsequent instruction based on the amount and direction of PE shifting specified in the subsequent instruction. Then, the control circuit 21a compares the data write PE 30 and the data read PE 30, and outputs a forwarding path selection signal according to the amounts and directions of the PE shifting. The amount of PE shifting refers to a distance from itself 30 (zero-point) to the data write/read PE 30, which is located in either upward or downward direction (or right or left direction) from itself 30. The direction of PE shifting indicates either the upward or downward direction from itself 30. In the case where PE shifting can be made in the ±2 PE range of itself 30, the PEs 30 in the range are specified as “Upward 2”, “Upward 1”, “Downward 0” (i.e. itself 30), “Downward 1” and “Downward 2”. In the example of FIG. 1, the PE shifting amount and direction of PE0 in relation to PE1 is defined as Upward 1, i.e., PE0 is the first PE 30 up from PE1 (the shifting direction is Upward and the shifting amount is 1).

By providing the control circuit 21a of FIG. 5, it is possible to generate a forwarding path selection signal in the DEC stage of the subsequent instruction of FIG. 3. Accordingly, although the write operation of the preceding instruction has yet to be completed when the RR stage of the subsequent instruction is carried out, an operation can be performed in the EX stage of the subsequent instruction by making a selection from among data obtained from the forwarding paths established among the PEs 30 (the arrow X in FIG. 3). In this manner, the RAW hazard is avoided.

According to the present embodiment, each PE 30 has not only a path for forwarding data stored in the A register 3h of itself 30, but also paths for forwarding data stored in the A registers 3h of neighboring PEs 30 as well as the third PE shift 3e for making a selection from among these forwarding paths according to the control of the GP unit 2. Herewith, data forwarding can be performed with the neighboring PEs 30, in addition to within itself 30, thereby avoiding a RAW hazard. This leads to a reduction in the number of execute cycles compared to implementing hazard avoidance by a pipeline stall.

In addition, the control circuit 21a is provided in the GP unit 2 so as to, when a RAW hazard occurs, cause the third PE shift 3e to select a forwarding path according to the distance from the data write PE 30 of the preceding instruction and the distance to the data read PE 30 of the subsequent instruction. Accordingly, forwarding control with the neighboring PEs 30 can be performed according to the distance from the data write PE 30 of the preceding instruction and the distance to the data read PE of the subsequent instruction, whereby a RAW hazard is avoided. This leads to a reduction in the number of execute cycles compared to implementing hazard avoidance by a pipeline stall.

### Second Embodiment

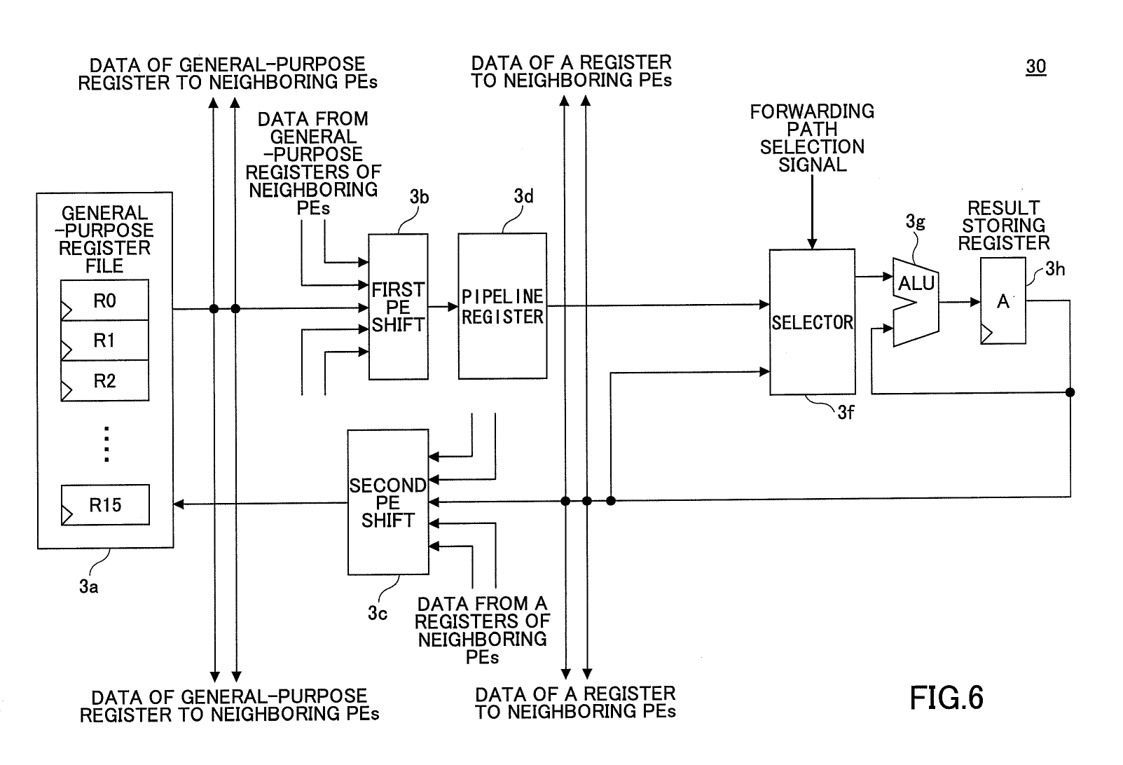

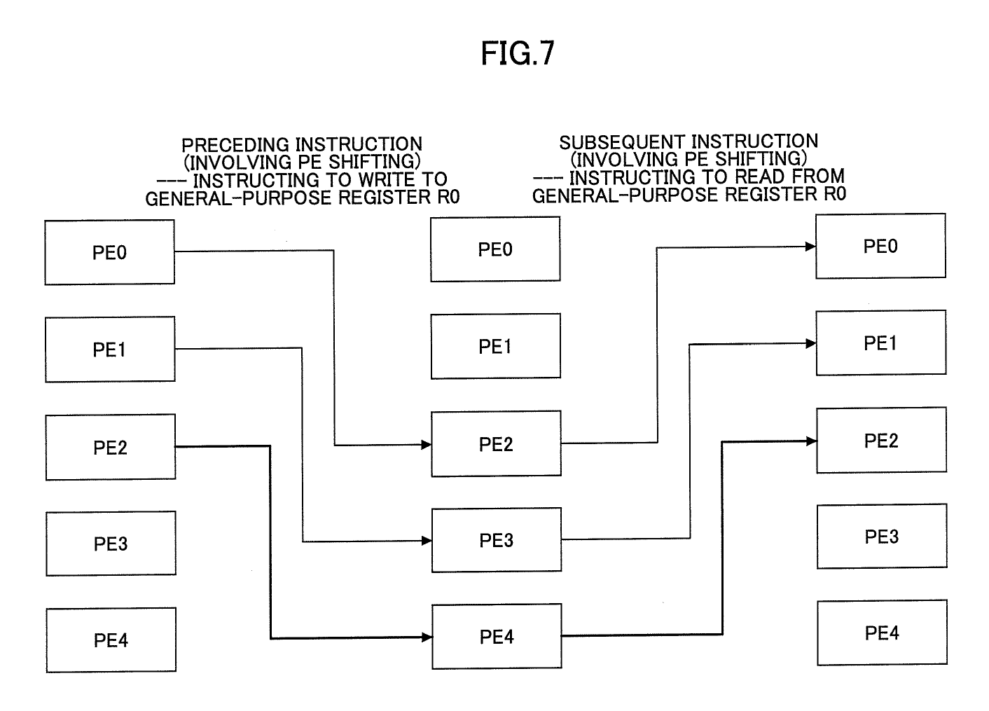

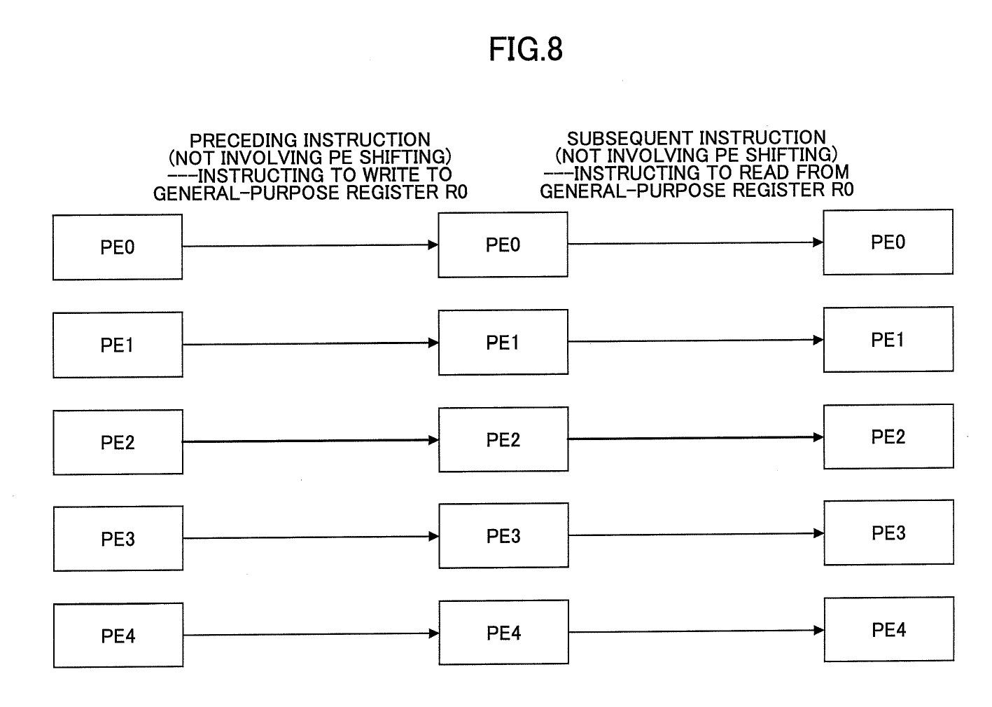

The second embodiment of the present invention is explained next with reference to FIGS. 6 through 8. Note that the same reference numerals are given to the components which are common to the first embodiment described above, and their explanations are omitted. FIG. 6 is a block diagram showing the details of the PE 30 of the SIMD microprocessor 1 according to the second embodiment. FIG. 7 illustrates the relationship between data write and data read among PEs 30 in relation to a preceding instruction and a subsequent instruction. FIG. 8 also illustrates the relationship between data write and data read among PEs 30 in relation to a preceding instruction and a subsequent instruction.

The present embodiment is different from the first embodiment in not having the third PE shift 3e in each PE 30 of the PE unit 3 and the paths for forwarding data stored in the A registers 3h of the neighboring PEs 30. Accordingly, the forwarding path from the A register 3h of itself 30 is directly connected to the selector 3f.

According to the present embodiment, although data forwarding with the neighboring PEs 30 cannot be performed, a RAW hazard can be avoided in the case of FIG. 7 or FIG. 8, for example. In the case of FIG. 7, the preceding instruction specifies writing of the operation result in the R0 register of the second PE 30 down from itself 30. The subsequent instruction specifies data reading from the R0 register of the second PE 30 down from itself 30. At this point, a RAW hazard related to the R0 register takes place. In this case, the control circuit 21a in the SCU 21 of the GP unit 2 detects that a data write PE 30 regarding the preceding instruction matches a data read PE 30 regarding the subsequent instruction, i.e., the preceding instruction and subsequent instruction indicate a PE 30 of the same number. Then, the control circuit 21a outputs a forwarding path selection signal to switch the selector 3f so as to forward the data of the A register 3h. In this manner, the RAW hazard is avoided.

In the case of FIG. 8, the preceding instruction specifies writing of the operation result in the R0 register without PE shifting. The subsequent instruction specifies data reading from the R0 register without PE shifting. In this case also, as in the case of FIG. 7, the control circuit 21a in the SCU 21 of the GP unit 2 detects that a data write PE 30 regarding the preceding instruction matches a data read PE 30 regarding the subsequent instruction, i.e., the preceding instruction and subsequent instruction indicate a PE 30 of the same number. Then, the control circuit 21a outputs a forwarding path selection signal to switch the selector 3f so as to forward the data of the A register 3h. In this manner, the RAW hazard is avoided.

According to the present embodiment, the control circuit 21a in the SCU 21 of the GP unit 2 detects that the data write PE 30 regarding the preceding instruction matches the data read PE regarding the subsequent instruction, and outputs a forwarding path selection signal so as to forward the data of the A register 3h. Therefore, if a PE 30 has a forwarding path established in itself, it is possible to avoid a RAW hazard caused when the data write PE 30 regarding the preceding instruction matches the data read PE 30 regarding the subsequent instruction by providing the control circuit 21a in the GP unit 2.

Note that it is not essential to provide the control circuit 21a in the SCU 21 of the GP unit; however, since the control circuit 21a refers to an instruction executed inside the GP unit 2, the control circuit 21a is preferably provided at least inside the GP unit 2.

In summary, according to one embodiment of the present invention, forwarding paths from neighboring processor elements and a selection unit for selecting a forwarding path are provided in a SIMD microprocessor having multiple processor elements, each of which reads data stored in a register file of a neighboring processor element, causes its own ALU to perform an operation on the read data, and writes the operation result in a register of a neighboring processor element. When a RAW hazard occurs, because the forwarding paths and the selection unit are provided, data forwarding can be performed with the neighboring processor elements, in addition to within the own processor element, thereby avoiding the RAW hazard. This leads to a reduction in the number of execute cycles compared to implementing hazard avoidance by a pipeline stall.

According to one embodiment of the present invention, the control unit controls the selection unit, when a RAW hazard occurs, to select a forwarding path according to a distance to a data write processor element specified by a preceding instruction and a distance to a data read processor element specified by a subsequent instruction. Accordingly, data forwarding with the neighboring processor elements can be controlled according to the distance to the data write processor element specified by the preceding instruction and the distance to the data read processor element specified by the subsequent instruction, thereby avoiding the RAW hazard. This leads to a reduction in the number of execute cycles compared to implementing hazard avoidance by a pipeline stall.

According to one embodiment of the present invention, when a RAW hazard occurs, the control unit controls to perform data forwarding if the data write processor element specified by the preceding instruction matches the data read processor element specified by the subsequent instruction. Therefore, a RAW hazard occurring when the data write processor element specified by the preceding instruction matches the data read processor element specified by the subsequent instruction can be avoided. This leads to a reduction in the number of execute cycles compared to implementing hazard avoidance by a pipeline stall.

According to one embodiment of the present invention, when a RAW hazard occurs, a forwarding path is selected according to a distance to a data write processor element specified by a preceding instruction and a distance to a data read processor element specified by a subsequent instruction. Therefore, even if the data write processor element specified by the preceding instruction does not match the data read processor element specified by the subsequent instruction, the selection of a forwarding path can be made, thereby avoiding the RAW hazard. This leads to a reduction in the number of execute cycles compared to implementing hazard avoidance by a pipeline stall.

The present invention is not limited to the above described embodiments. It should be understood that various changes and modification may be made to the particular examples without departing from the scope of the present invention.

This application is based on Japanese Patent Application No. 2008-196426 filed on Jul. 30, 2008, the contents of which are hereby incorporated herein by reference.

What is claimed is:

1. A SIMD microprocessor comprising:
a processor element unit including a plurality of processor elements; and
a global processor unit configured to interpret a program pre-recorded in a memory and supply a control signal to the processor element unit;
wherein each of the processor elements includes an operational circuit, a first forwarding path for forwarding, to an input side of the operational circuit, an operation result obtained by the operational circuit, second forwarding paths, each of which forwards, to the input side of the operational circuit, an operation result obtained by an operational circuit of a neighboring processor element among the plurality of processor elements, and a selection unit configured to select one of the first forwarding path and the second forwarding paths.

2. The SIMD microprocessor as claimed in claim 1, further comprising:
a detection unit configured to detect a read after write hazard occurring when the program is executed by the global processor unit; and
a control unit configured to, when the detection unit detects the read after write hazard, cause the selection unit to make the selection according to a distance to the processor element specified by a preceding instruction of the program to be a data write processor element in which an operation result is to be written and a distance to the processor element specified by a subsequent instruction of the program to be a data read processor from which the operation result is to be read.

3. The SIMD microprocessor as claimed in claim 1, further comprising:
a control unit configured to detect that the processor element specified by a preceding instruction of the program to be a data write processor element in which an operation result is to be written matches the processor element specified by a subsequent instruction of the program to be a data read processor from which the operation result is to be read, and causes the operational circuit to perform an operation using the forwarding path when the detection is made.

4. An operation method applied to a SIMD microprocessor including a processor element unit including a plurality of processor elements, each of which processor elements includes an operational circuit and a forwarding path for forwarding, to an input side of the operational circuit, an operation result obtained by the operational circuit, and a global processor unit configured to interpret a program pre-recorded in a memory and supply a control signal to the processor element unit, the operation method including the step of selecting, as an input of the operational circuit, one of the operation result obtained by the operational circuit and operation results obtained by operational circuits of neighboring processor elements among the plural processor elements according to a distance to the processor element specified by a preceding instruction of the program to be a data write processor element in which an operation result is to be written and a distance to the processor element specified by a subsequent instruction of the program to be a data read processor from which the operation result is to be read.

5. An operation method applied to a SIMD microprocessor including a processor element unit including a plurality of processor elements, each of which processor elements includes an operational circuit and a forwarding path for forwarding, to an input side of the operational circuit, an operation result obtained by the operational circuit, and a global processor unit configured to interpret a program pre-recorded in a memory and supply a control signal to the processor element unit, the operation method including the steps of:
detecting that the processor element specified by a preceding instruction of the program to be a data write processor element in which an operation result is to be written matches the processor element specified by a subsequent instruction of the program to be a data read processor from which the operation result is to be read; and
using the operation result of the forwarding path as an input of the operational circuit when the detection is made.
